(19) United States
(12) Patent Application Publication
(10) Pub. No.: US 2017/0133844 A1
(43) Pub. Date: May 11, 2017

(54) FIRE DETECTION, AUTOMATED SHUTOFF AND ALERTS USING DISTRIBUTED ENERGY RESOURCES AND MONITORING SYSTEM

(71) Applicant: Enphase Energy, Inc., Petaluma, CA (US)

(72) Inventors: Jay Richard Goldin, Sebastopol, CA (US); Mark Baldassari, Santa Rosa, CA (US); John Scott Berdner, Grass Valley, CA (US)

(21) Appl. No.: 15/345,012

(22) Filed: Nov. 7, 2016

Related U.S. Application Data
(60) Provisional application No. 62/252,331, filed on Nov. 6, 2015.

(51) Int. Cl. H02J 3/00; G05B 9/02

(52) U.S. Cl. CPC H02J 3/00; G05B 9/02; H02J 2003/001

(57) ABSTRACT

A method and apparatus for using distributed energy resources (DERs) to detect a fire event. In one embodiment, the method comprises receiving, at a controller comprising at least one processor, temperature data from at least one power conditioner of a DER; analyzing, by the controller, the temperature data with respect to at least one temperature reference; determining, by the controller and based on analyzing the temperature data with respect to the at least one temperature reference, whether a fire event exists; and when it is determined that a fire event exists, performing, by the controller, at least one action for addressing the fire event.

### CROSS-REFERENCE TO RELATED APPLICATIONS

This application claims benefit of U.S. provisional patent application Ser. No. 62/252,331, entitled “Fire Detection, Automated Shutoff and Alerts using Distributed Energy Resources and Monitoring System”, and filed Nov. 6, 2015, which is herein incorporated in its entirety by reference.

### BACKGROUND OF THE INVENTION

Field of the Invention

Embodiments of the present disclosure relate generally to automated fire detection, shutoff and alerts and, more particularly, using distributed energy resources for automated fire detection, shutoff and alerts.

Description of the Related Art

Fire safety codes for buildings and structures are critical to minimizing losses due to fires, such as property, information, and, mostly importantly, life. In order to meet relevant fire safety regulations, structures such as buildings must have fire detection and alarm systems. Such systems are generally located within the structure and thus are not effective with respect to fire events that occur outside of the structure until the fire has spread within the structure.

Therefore, there is a need in the art for automatically detecting and generating an alert for a fire event that occurs outside of a structure.

### SUMMARY OF THE INVENTION

Embodiments of the present invention generally relate to distributed energy resources enabled for automated fire detection, shutoff and alerts substantially as shown in and/or described in connection with at least one of the figures, as set forth more completely in the claims.

Various advantages, aspects and novel features of the present disclosure, as well as details of an illustrated embodiment thereof, will be more fully understood from the following description and drawings.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a system for power conditioning and automated fire detection and notification in accordance with one or more embodiments of the present invention;

FIG. 2 is a block diagram of a power conditioner controller in accordance with one or more embodiments of the present invention;

FIG. 3 is a block diagram of a DER controller in accordance with one or more embodiments of the present invention;

FIG. 4 is a block diagram of a master controller in accordance with one or more embodiments of the present invention; and

FIG. 5 is a flow diagram of a method for using DER resources for detecting a fire event in accordance with one or more embodiments of the present invention.

### DETAILED DESCRIPTION

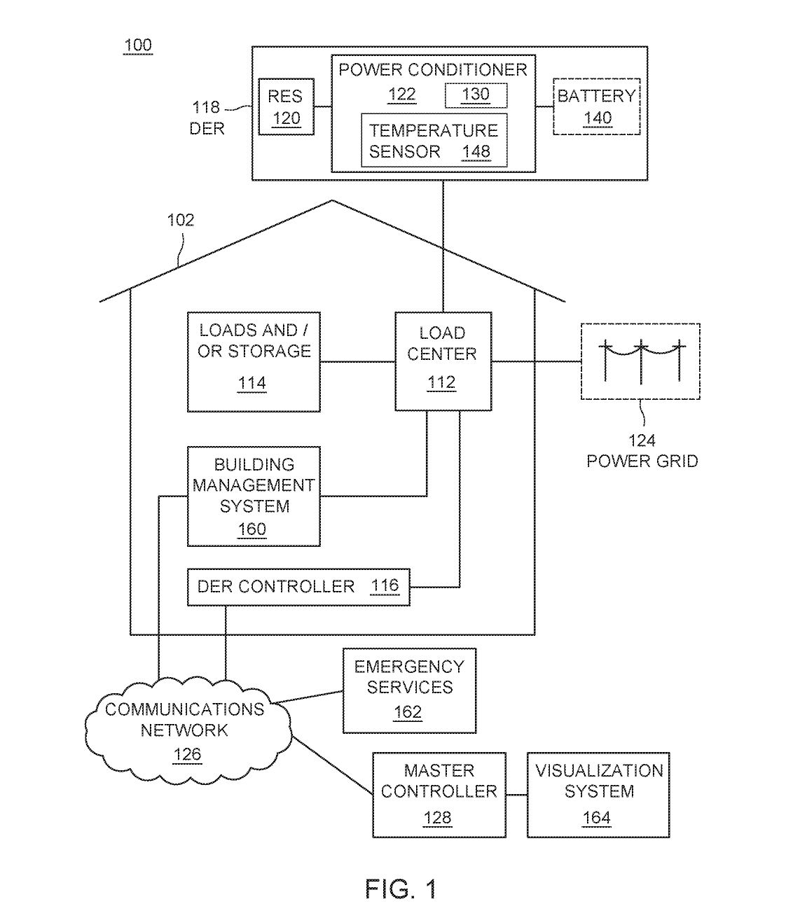

FIG. 1 is a block diagram of a system 100 for power conditioning and automated fire detection and notification in accordance with one or more embodiments of the present invention. This diagram only portrays one variation of the myriad of possible system configurations. The present invention can function in a variety of environments and systems.

The system 100 comprises a structure 102, such as a residential or commercial building, coupled to a distributed energy resource (DER) 118 and a power grid 124 (e.g., a commercial power grid). The DER 118 is situated external to the structure 102; for example, the DER 118 may be located on the roof of the structure 102.

The structure 102 comprises a load center 112 coupled to the DER 118 and to the power grid 124, as well as to one or more loads and/or storage devices 114 (e.g., appliances, electric hot water heaters, and the like), and a DER controller 116.

The DER 118 comprises at least one renewable energy source (RES) 120 coupled to at least one power conditioner 122; for example, the DER 118 may comprise a plurality of RESs 120 coupled to a plurality of power conditioners 122 in a one-to-one correspondence. The RESs 120 may be any type of system for generating DC power from a renewable form of energy, such as wind, solar, hydro, and the like. The power conditioners 122 convert the generated DC power to AC power that is power grid compliant and couple the AC power to the load center 112. The generated AC power may be further coupled from the load center 112 to the one or more loads and/or storage devices 114 and/or to the power grid 124. In some embodiments the power conditioners 122 are bidirectional converters that can convert DC power from the RESs 120 and/or one or more batteries 140 (or other types of energy storage/delivery devices) to AC power that is coupled to the load center 112, and can convert AC power (e.g., from the grid 124) to DC power that may be stored, for example in the batteries 140. In some alternative embodiments, the power conditioners 122 may be AC-AC converters that convert one type of AC power to another type of AC power. In other alternative embodiments, the power conditioners 122 may be DC-DC converters that convert one type of DC power to another type of DC power; in some of such embodiments, the DC-DC converters may be coupled to a main DC-AC inverter for converting the generated DC output to an AC output.

In one or more embodiments, the DER 118 may comprise one or more batteries 140 coupled to one or more power conditioners 122; for example, the DER 118 may comprise a plurality of batteries 140 coupled to a plurality of power conditioners 122 in a one-to-one correspondence. In such embodiments, the power conditioners 122 coupled to the batteries 140 are bidirectional DC-AC converters that can convert AC to DC for storage in the batteries 140 and can convert energy stored in the batteries 140 to an output AC that is coupled to the load center 112.

In certain embodiments, the RESs 120 are photovoltaic (PV) modules and the power conditioners 122 are DC-AC inverters. In some of such embodiments, the PV modules are coupled to the inverters in a one-to-one correspondence; in other of such embodiments, the PV modules are coupled to a single, centralized DC-AC inverter. In one or more embodiments the DER 118 may operate as a microgrid when the power grid 124 is unavailable; in one or more alternative embodiments the system 100 is not connected to any other power grid and the DER 118 operates as an off-grid microgrid.

The DER controller 116 is coupled to the load center 112 for communicating with the power conditioners 122 using power line communications (PLC), although additionally or alternatively other types of wired and/or wireless techniques may be used. The DER controller 116 may provide operative control of the DER 118 and/or receive data or information from the DER 118. For example, the DER controller 116 may be a gateway that receives data (e.g., alarms, messages, operating data and the like) from the power conditioners 122 and communicates the data and/or other information to a remote device or system, such as a master controller 128 described below. The DER controller 116 may also send control signals to the power conditioners 122, such as control signals generated by the DER controller 116 or sent to the DER controller 116 by the master controller 128.

The DER controller 116 is further communicatively coupled to the master controller 128 via a communications network 126 (e.g., the Internet) for sending information to and/or receiving information from the master controller 128. The DER controller 116 may utilize wired and/or wireless techniques for coupling to the communications network 126; in some embodiments, the DER controller 116 may be wirelessly coupled to the communications network 126 via a commercially available router.

Each of the power conditioners 122 comprises a temperature sensor 148 for monitoring temperature of the corresponding power conditioner 122. In some embodiments, the temperature sensor 148 may be a thermocouple which measures temperature. The temperature information from the temperature sensor 148 may be used by the power conditioner 122 for regulating power conversion and/or providing notification of an abnormal temperature event for the power conditioner. For example, the power conditioner 122 may shut down power conversion when the measured temperature exceeds a threshold; additionally or alternatively, the power conditioner 122 may communicate a notification of such an event to the controller 116 and/or the master controller 128.

In accordance with one or more embodiments of the present invention, for each power conditioner of the DER 118, the corresponding temperature sensor 148 provides information for detecting a fire event proximate the corresponding power conditioner 122, reporting the fire event, and taking appropriate actions in response to the fire event. Each power conditioner 122 periodically obtains temperature data (e.g., measured temperature) from the corresponding temperature sensor 148 and communicates the temperature data to the controller 116 and/or the master controller 128.

In some embodiments, the controller 116 and/or the master controller 128 may compare received temperature data to a reference temperature (i.e., a threshold) for one or more power conditioners 122 and/or the DER 118 in order to detect a potential fire event. The reference temperature may be determined by the controller 116 and/or the master controller 128 from historical temperature data for the DER 118 (e.g., an average temperature and/or standard deviation may be computed); alternatively, the reference temperature may be a user-selectable value, a preset value (e.g., based on observed weather), or the like.

In other embodiments, the controller 116 and/or the master controller 128 may calculate an expected temperature curve/range for each power conditioner 122 and identify any divergence from the expected temperature curve/range in order to detect a potential fire event. Such an expected temperature curve/range may be time/date dependent based on history and/or observed weather. One or more of the following may then be used in detecting a fire event: values higher than average for one or more power conditioners 122; variation from expected temperature for one or more power conditioners 122; variation in temperature among adjacent power conditioners 122; or similar types of temperature data analysis.

In some embodiments, the temperature data may be based on temporal and/or spatial relationships between one or more other DERs 118 (or external temperature sensors). By using relationships between nearby sensors and over time, such data can be used to establish acceptable variances relative to the other sensors and only trigger a fire notification if the temperatures go outside those relative values. For example, the temporal-based data may be used in embodiments where some DER components are shaded when others are in full sun and the shading pattern may move over time (due to sun movement). As another example, the spatial-based data may be used in embodiments where some DER components have a different mounting orientation than others, e.g., south-facing versus west-facing, higher versus lower position, and the like; the spatial-based data can then be used to compensate for those normal variances due to location (e.g., the fact that hot air rises). By compensating for the regular variations due to temporal and/or spatial factors, alarm thresholds can be adjusted to improve detection of abnormal conditions while at the same time reducing false alarming of the system.

Once a potential fire event is detected, the controller 116 and/or the master controller 128 may use one or more techniques for verifying the potential fire event is an actual fire event rather than a false fire detection. For example, temperature data for one or more adjacent power conditioners 122 and/or other parts of the DER 118 (as well as other locally-located DERs 118) may be analyzed. Additionally or alternatively, loss of communication between the DER 118 and the controller 116 may be used in determining an actual fire event, e.g., the loss of communication may be correlated to temperature rise for one or more power conditioners 122. The master controller 128 may use other external data sources, e.g. weather data and/or temperature data from other nearby systems, to better estimate the normal expected temperature and therefore increase detection while minimizing false signals.

In one or more embodiments, the detection system described herein may be adaptive to improve detection while minimizing false alarms.

Upon determining that a fire event has occurred, the controller 116 and/or the master controller 128 can perform actions for mitigating and/or reporting the fire event. For example, as part of controlling the fire event the controller 116 and/or the master controller 128 may shut down power conversion in the DER 118 (although in one or more of such embodiments the power conditioners 122 may continue monitoring the temperature data and providing such data to the controller 116); activate local sprinklers and/or other types of fire extinguishing/control devices (e.g., via a MODBUS); and/or perform similar control techniques. In some embodiments, the controller 116 and/or the master controller 128 may initiate one or more actions at the load center 112, such as remote shut off of electrical circuits at the load center 112 (e.g., to shut off a main inverter or the main power circuit).

Additionally or alternatively, the controller 116 and/or the master controller 128 can provide notification of the detected fire event. For example, the controller 116 and/or the master controller 128 can alert a building management system 160 (e.g., via BACNET); activate a local alarm system (e.g., via a relay closure); alert registered recipients (such as an owner, third-party operator or host, or the like), operations and maintenance personnel, and/or local authorities (e.g., triggering a call to emergency services 162, such as 911 emergency services, with a recording; an automated call to emergency services 162, a text message/SMS message and/or email alert, or the like). The master controller 128 may include the ability to generate emails, text messages, and/or automated phone messages to alert various parties (owners, maintenance personnel, emergency personnel such as fire fighters, and the like) of detected fire.

Alerts sent may also contain geolocation information for identifying the physical location of the detected fire event and/or the relative position of the detected fire event (e.g., a street address of the site; GPS coordinates for the site and/or specific location of the fire event within the DER 118; a site map; a mapping of power conditioner serial number to physical location; or the like). For example, physical location data and/or relative positioning data with respect to the DER 118 (such as GPS coordinates, a site map, or the like), e.g., as obtained from the power conditioners 122. In some embodiments, the geolocation information may include a reference location for each power conditioner 122, for example based on GPS information with adjustment from a reference location.

In certain embodiments, the controller 116 and/or the master controller 128 may generate a visualization display of the temperature data for the DER 118, e.g., on a visualization system 164 that is coupled to the master controller 128. For example, a histogram of the temperature data or other type of visual representation of the temperature data may be generated. In one or more embodiments, the temperature data may be depicted in a two-dimensional layout comprising a plurality of display images, where each display image corresponds to a particular power conditioner 122 and the display layout corresponds to the physical layout of the DER 118. In such embodiments, one or more color parameters of each display image may be varied according to the temperature data for the corresponding power conditioner 122. For example, the display images may vary from white to red where the saturation level of the hue increases as the corresponding temperature data increases. Examples of such visualization may be found in commonly assigned U.S. Pat. No. 8,963,923, entitled “Method and Apparatus for Electrical Power Visualization” and issued on Feb. 24, 2015, and commonly assigned U.S. patent application Ser. No. 14/166,269, entitled “Method and Apparatus for Energy Data Visualization” and filed Jan. 28, 2014, each of which is herein incorporated in its entirety by reference.

In one or more alternative embodiments, the temperature sensors 120 may be located external to the power conditioners 120. For example, the temperature sensors 120 may be coupled to the exterior of the power conditioners 122, coupled to another part of the DER 118 (e.g., to the RESs, to the batteries 140, to racking on which the RESs are coupled), coupled to the exterior of the structure 102 (e.g., to the rooftop of a building), or coupled to other elements of the system 100 (e.g., wiring or electrical connections). In certain embodiments, the temperature sensor 148 may be a thermocouple built, for example, into an electrical junction box, a connector between PV modules, or any other suitable element of the system 100. in some embodiments, the temperature sensor 148 may be located within the battery 140 (or another type of energy storage/delivery device coupled to the power conditioner 122).

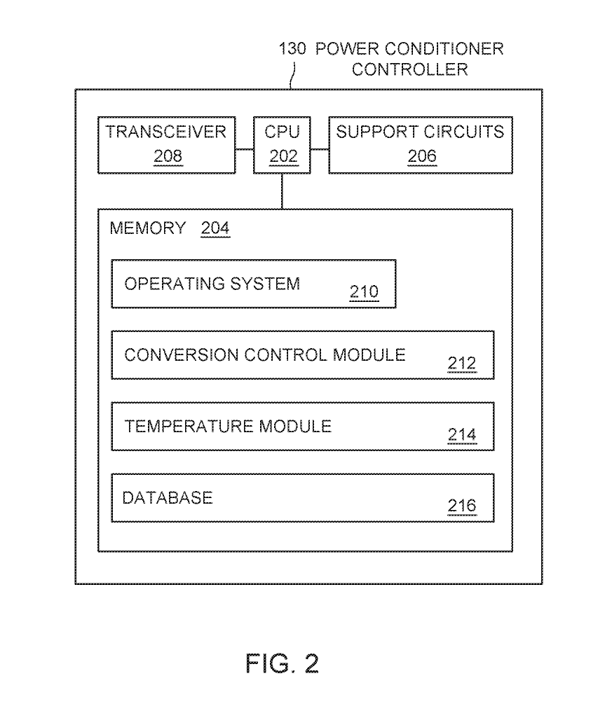

Each of the power conditioners 122 comprises a controller 130, described below with respect to FIG. 2, for controlling the corresponding power conditioner 122.

FIG. 2 is a block diagram of a power conditioner controller 130 in accordance with one or more embodiments of the present invention. The power conditioner controller 130 comprises at least one central processing unit (CPU) 202 coupled to each of a memory 204, support circuits 206 (i.e., well known circuits used to promote functionality of the CPU 202, such as a cache, power supplies, clock circuits, buses, input/output (I/O) circuits, and the like), and a transceiver 208 that is communicatively coupled to the DER controller 116.

The CPU 202 may comprise one or more conventionally available microprocessors or microcontrollers. The power conditioner controller 130 may be implemented using a general purpose computer that, when executing particular software, becomes a specific purpose computer for performing various embodiments of the present invention. In one or more embodiments, the CPU 202 may be a microcontroller comprising internal memory for storing controller firmware that, when executed, provides the controller functionality described herein. In some embodiments, each DER controller 116 may additionally or alternatively comprise one or more application specific integrated circuits (ASIC) for performing one or more of the functions described herein.

The memory 204 may comprise random access memory, read only memory, removable disk memory, flash memory, and various combinations of these types of memory; the memory 204 is sometimes referred to as main memory and may, in part, be used as cache memory or buffer memory. The memory 204 generally stores an operating system (OS) 210, such as one of a number of available operating systems for microcontrollers and/or microprocessors (e.g., LINUX, Real-Time Operating System (RTOS), and the like). The memory 204 further stores non-transient processor-executable instructions and/or data that may be executed by and/or used by the CPU 202. These processor-executable instructions may comprise firmware, software, and the like, or some combination thereof.

The memory 204 stores various forms of application software, such as a power conversion control module 212 for controlling power conversion by the power conditioners 122, and temperature module 214 which may assist in obtaining measured temperature data from the temperature sensor 148 and/or communicating the temperature data to the DER controller 116. The memory 204 additionally stores a database 216 for storing data related to power conversion and/or the present invention, such as one or more temperature references, information pertaining to actions to be taken when there is a fire event, and the like. In various embodiments, the power conversion control module 212, the temperature module 214, and the database 216, or portions thereof, may be implemented in software, firmware, hardware, or a combination thereof.

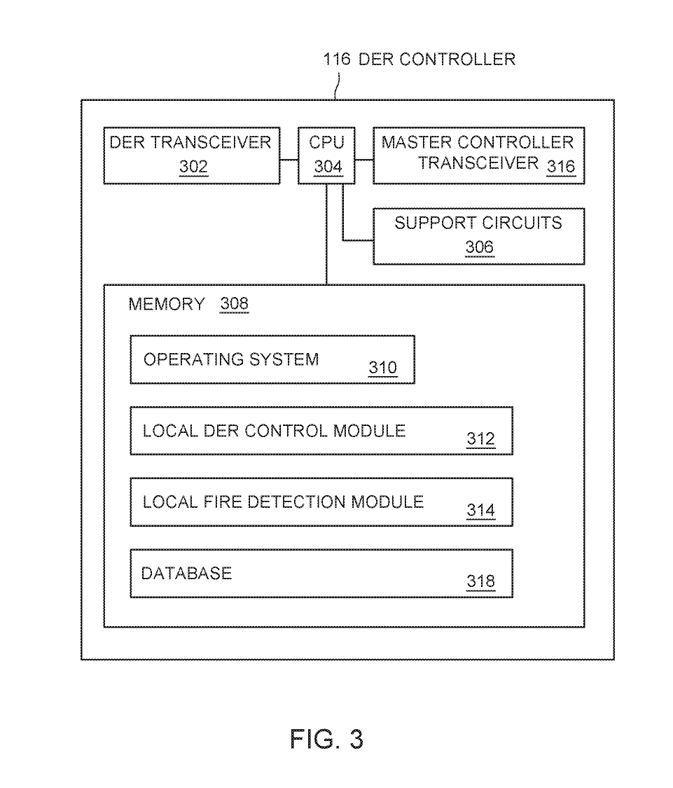

FIG. 3 is a block diagram of a DER controller 116 in accordance with one or more embodiments of the present invention. The DER controller 116 comprises a DER transceiver 302, a master controller transceiver 316, support circuits 306, and a memory 308 each coupled to at least one CPU 304. The CPU 304 may comprise one or more conventionally available microprocessors; additionally or alternatively, the CPU 304 may include one or more application specific integrated circuits (ASICs). In some embodiments, the CPU 304 may be a microcontroller comprising internal memory for storing controller firmware that, when executed, provides the controller functionality herein. The DER controller 116 may be implemented using a general purpose computer that, when executing particular software, becomes a specific purpose computer for performing various embodiments of the present invention.

The support circuits 306 are well known circuits used to promote functionality of the CPU 304. Such circuits include, but are not limited to, a cache, power supplies, clock circuits, buses, network cards, input/output (I/O) circuits, and the like.

The DER transceiver 302 is communicatively coupled to the power conditioners 122, and the master controller transceiver 316 is communicatively coupled to the master controller 128 via the communications network 126. The transceivers 302 and 316 may utilize wireless (e.g., based on standards such as IEEE 802.11, Zigbee, Z-wave, or the like) and/or wired (e.g., PLC) communication techniques for such communication, for example a WI-FI or WI-MAX modem, 3G modem, cable modem, Digital Subscriber Line (DSL), fiber optic, or similar type of technology.

The memory 308 may comprise random access memory, read only memory, removable disk memory, flash memory, and various combinations of these types of memory. The memory 308 is sometimes referred to as main memory and may, in part, be used as cache memory or buffer memory. The memory 308 generally stores an operating system (OS) 310 of the DER controller 116. The OS 310 may be one of a number of available operating systems for microcontrollers and/or microprocessors.

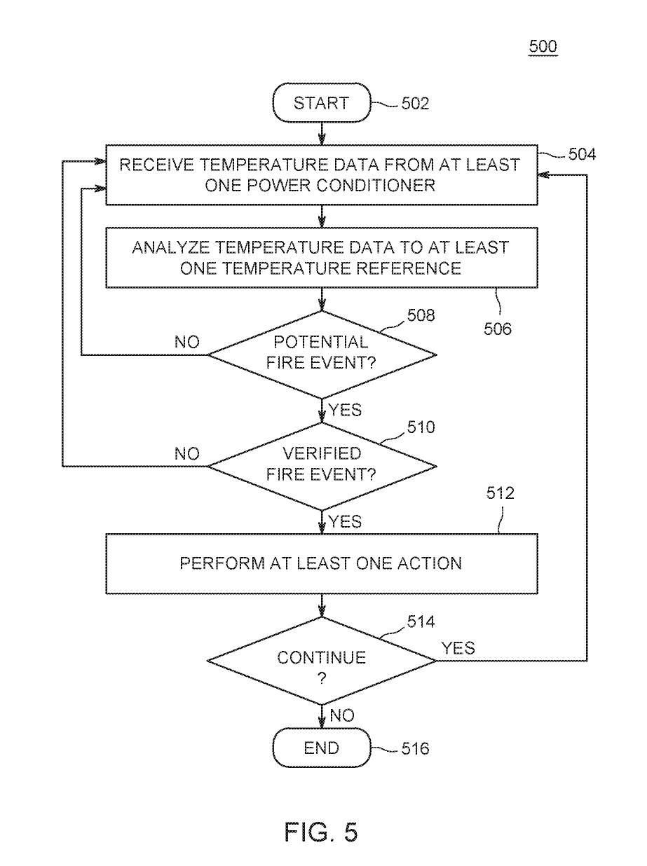

The memory 308 stores various forms of application software, such as a local DER control module 312 for providing operative control of the DER 118 (e.g., providing command instructions to the power conditioners 122 regarding power production levels), and a local fire detection module 314 which, in some embodiments, processes temperature data as described herein and/or performs one or more of the actions for addressing a fire event as described herein. The local fire detection module 314 may additionally transmit temperature data and/or data resulting from analysis of the temperature data to the master controller 128. Further detail on the functionality provided by the local fire detection module 314 is described below with respect to FIG. 5.

The memory 308 additionally stores a database 318 for storing data, such as data related to the DER 118, temperature data, temperature references, one or more algorithms for analyzing temperature data, results of temperature data analysis, and the like. In various embodiments, the local DER control module 312, the local fire detection module 314, and the database 318, or portions thereof, may be implemented in software, firmware, hardware, or a combination thereof.

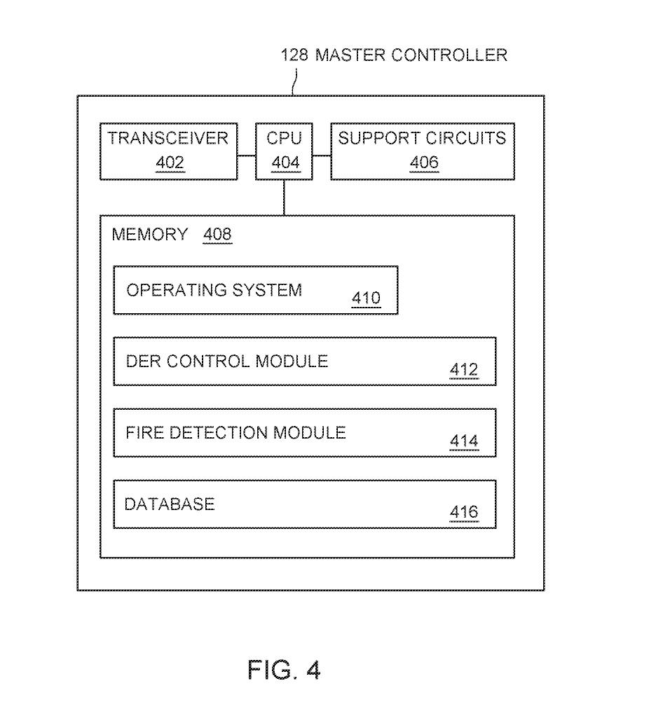

FIG. 4 is a block diagram of a master controller 128 in accordance with one or more embodiments of the present invention. The master controller 128 comprises a transceiver 402, support circuits 406, and a memory 408 each coupled to at least one central processing unit (CPU) 404. The CPU 404 may comprise one or more conventionally available microprocessors; additionally or alternatively, the CPU 404 may include one or more application specific integrated circuits (ASICs). In some embodiments, the CPU 404 may be a microcontroller comprising internal memory for storing controller firmware that, when executed, provides the controller functionality herein. The master controller 128 may be implemented using a general purpose computer that, when executing particular software, becomes a specific purpose computer for performing various embodiments of the present invention.

The support circuits 406 are well known circuits used to promote functionality of the CPU 404. Such circuits include, but are not limited to, a cache, power supplies, clock circuits, buses, network cards, input/output (I/O) circuits, and the like.

The transceiver 402 is communicatively coupled to the DER controller 116 via the communications network 126. The transceiver 402 may utilize wireless (e.g., based on standards such as IEEE 802.11, Zigbee, Z-wave, or the like) and/or wired communication techniques for such communication, for example a WI-FI or WI-MAX modem, 3G modem, cable modem, Digital Subscriber Line (DSL), fiber optic, PLC, or similar type of technology.

The memory 408 may comprise random access memory, read only memory, removable disk memory, flash memory, and various combinations of these types of memory. The memory 408 is sometimes referred to as main memory and may, in part, be used as cache memory or buffer memory. The memory 408 generally stores an operating system (OS) 410 of the master controller 128. The OS 410 may be one of a number of available operating systems for microcontrollers and/or microprocessors.

The memory 408 stores various forms of application software, such as a DER control module 412 for providing operative control of the DER 118 (e.g., providing command instructions to the DER controller 116 regarding power production levels) and, in some embodiments, additional DERs. The memory 408 further comprises a fire detection module 414 which, in some embodiments, processes temperature data from one of more DERs (e.g., the DER 118) as described herein and/or performs one or more of the actions for addressing a fire event as described herein. The fire detection module 414 may additionally transmit temperature data and/or data resulting from analysis of the temperature data to the DER controller 116 (and in some embodiments to DER controllers associated with other DERs). Further detail on the functionality provided by the fire detection module 414 is described below with respect to FIG. 5.

The memory 408 additionally stores a database 416 for storing data, such as data related to the operation of the DER 118, temperature data, temperature references, one or more algorithms for analyzing temperature data, results of temperature data analysis, and the like. In various embodiments, the DER control module 412, the fire detection module 414, and the database 416, or portions thereof, may be implemented in software, firmware, hardware, or a combination thereof.

FIG. 5 is a flow diagram of a method 500 for using DER resources for detecting a fire event in accordance with one or more embodiments of the present invention. In one or more embodiments, the method 500 is an implementation of the DER controller's local fire detection module 314 described above. In other embodiments, the method 500 is an implementation of the master controller's fire detection module 414 described above. In still other embodiments, the method 500 may in part be performed by the local fire detection module 314 and in part by the fire detection module 414. In certain embodiments, a computer readable medium comprises a program that, when executed by a processor, performs the method 500 that is described in detail below.

The method 500 begins at step 502 and proceeds to step 504. At step 504, temperature data is received from at least one power conditioner of a DER (e.g., one or more of the power conditioners 122 of the DER 118). The temperature data is obtained by the one or more power conditioners from a corresponding temperature sensor which measures the temperature of the associated power conditioner, such as the temperature sensor 148. The temperature data may be received via any of a number of known wired communication techniques, such as power line communications, and/or known wireless communication techniques.

The method 500 proceeds to step 506, where the temperature data is analyzed with respect to at least one temperature reference in order to detect a potential fire event. The at least one temperature reference may be one or more of a temperature threshold, an expected temperature range, an expected temperature curve, or the like. The at least one temperature reference may be predetermined and/or dynamically adjustable, for example based on history, observed weather, or the like. In some embodiments, the at least one temperature reference may be determined from historical temperature data (e.g., historical data for the corresponding DER), such as an average temperature and/or standard deviation.

The method 500 proceeds to step 508 where a determination is made, based on the analysis of the temperature data with respect to the at least one temperature reference, whether a potential fire event exists. In some embodiments, a potential fire event is considered to exist when the at least one temperature reference exceeds a temperature threshold, an expected temperature range, or an expected temperature curve.

If the result of the determination at step 508 is no, that no potential fire event exists, the method 500 returns to step 504. If the result of the determination at step 508 is yes, that a potential fire event exists, the method 500 proceeds to step 510 where the potential fire event is analyzed to confirm whether or not it is an actual fire event. Generally, one or more of the following may be used in determining whether the potential fire event is a verified fire event: temperature values higher than average for one or more power conditioners, variation from expected temperature for one or more power conditioners, variation in temperature among adjacent power conditioners, or similar types of temperature data analysis.

If the result of the determination at step 510 is no, that the potential fire event is not actually a fire event, the method 500 returns to step 504. If the result of the determination at step 510 is yes, that the potential fire event is a verified fire event, the method 500 proceeds to step 512. In one or more embodiments, the detection of a potential fire event/verification of an actual fire event occurs during a single step; i.e., the detection of a potential event and verification of the event are part of the same analysis.

At step 512, in response to the determined fire event, one or more actions is taken to address the fire event, such as reporting the event (e.g., altering a building management system via, for example, BACNET; activating a local alarm system, for example via a relay closure; alerting one or more persons such as an owner or operator of the DER, operations and maintenance personal, local authorities, and the like, for example via an automated call, text/SMS message, or email alert), performing actions to mitigate the event (e.g., shutting down power conversion by the power conditioners; remote shut-off of electrical circuits such as a main circuit; activating local fire control/extinguishing devices such as sprinklers; automatically closing fire doors; and the like), and the like. Alert information communicated may additionally contain geolocation information for identifying the physical location of the detected fire event and/or the relative position of the detected fire event (e.g., a street address of the site; GPS coordinates for the site and/or specific location of the fire event within the DER; a site map; a mapping of power conditioner serial number to physical location; or the like).

The method 500 proceeds to step 514, where a determination is made whether to continue. If the result of the determination is yes, the method 500 returns to step 504; if the result of the determination is no, the method 500 proceeds to step 516 where it ends.

The foregoing description of embodiments of the invention comprises a number of elements, devices, circuits and/or assemblies that perform various functions as described. These elements, devices, circuits, and/or assemblies are exemplary implementations of means for performing their respectively described functions.

While the foregoing is directed to embodiments of the present invention, other and further embodiments of the invention may be devised without departing from the basic scope thereof, and the scope thereof is defined by the claims that follow.

1. A method for using distributed energy resources (DERs) to detect a fire event, comprising:
receiving, at a controller comprising at least one processor, temperature data from at least one power conditioner of a DER;
analyzing, by the controller, the temperature data with respect to at least one temperature reference;
determining, by the controller and based on analyzing the temperature data with respect to the at least one temperature reference, whether a fire event exists; and
when it is determined that a fire event exists, performing, by the controller, at least one action for addressing the fire event.

2. The method of claim 1, wherein each of the at least one power conditioners comprises a temperature sensor for obtaining the temperature data.

3. The method of claim 1, wherein determining whether the fire event exists comprises:
determining, by comparing the temperature data with respect to the at least one temperature reference, whether a potential fire event exists; and
when it is determined that the potential fire event exists, verifying that the first event exists based on further analysis of the temperature data.

4. The method of claim 3, wherein the further analysis of the temperature data comprises at least one of determining whether temperature values for one or more power conditioners of the DER are greater than an average value, comparing temperature variation for the one or more power conditioners to expected temperature variation, or comparing temperature variation among adjacent power conditioners.

5. The method of claim 1, wherein the at least one temperature reference is one or more of a temperature threshold, an expected temperature range, or an expected temperature curve.

6. The method of claim 1, wherein the at least one action comprises reporting the fire event.

7. The method of claim 1, wherein the at least one action is performed to mitigate the fire event.

8. An apparatus for using distributed energy resources (DERs) to detect a fire event, comprising:
a controller, comprising at least one processor, for:
(i) receiving temperature data from at least one power conditioner of a DER;
(ii) analyzing, the temperature data with respect to at least one temperature reference;
(iii) determining, based on analyzing the temperature data with respect to the at least one temperature reference, whether a fire event exists; and
(iv) when it is determined that a fire event exists, performing at least one action for addressing the fire event.

9. The apparatus of claim 8, wherein each of the at least one power conditioners comprises a temperature sensor for obtaining the temperature data.

10. The apparatus of claim 8, wherein determining whether the fire event exists comprises:
determining, by comparing the temperature data with respect to the at least one temperature reference, whether a potential fire event exists; and
when it is determined that the potential fire event exists, verifying that the first event exists based on further analysis of the temperature data.

11. The apparatus of claim 10, wherein the further analysis of the temperature data comprises at least one of determining whether temperature values for one or more power conditioners of the DER are greater than an average value, comparing temperature variation for the one or more power conditioners to expected temperature variation, or comparing temperature variation among adjacent power conditioners.

12. The apparatus of claim 8, wherein the at least one temperature reference is one or more of a temperature threshold, an expected temperature range, or an expected temperature curve.

13. The apparatus of claim 8, wherein the at least one action comprises reporting the fire event.

14. The apparatus of claim 8, wherein the at least one action is performed to mitigate the fire event.

15. A system for using distributed energy resources (DERs) to detect a fire event, comprising:
a distributed energy resource (DER) comprising a plurality of power conditioners; and
a controller, comprising at least one processor and communicably coupled to the DER, for:
(i) receiving temperature data from at least one power conditioner of the plurality of power conditioners;
(ii) analyzing, the temperature data with respect to at least one temperature reference;
(iii) determining, based on analyzing the temperature data with respect to the at least one temperature reference, whether a fire event exists; and
(iv) when it is determined that a fire event exists, performing at least one action for addressing the fire event.

16. The system of claim 15, wherein each of the at least one power conditioners comprises a temperature sensor for obtaining the temperature data.

17. The system of claim 15, wherein determining whether the fire event exists comprises:
determining, by comparing the temperature data with respect to the at least one temperature reference, whether a potential fire event exists; and
when it is determined that the potential fire event exists, verifying that the first event exists based on further analysis of the temperature data.

18. The system of claim 17, wherein the further analysis of the temperature data comprises at least one of determining whether temperature values for one or more power conditioners of the plurality of power conditioners are greater than an average value, comparing temperature variation for the one or more power conditioners to expected temperature variation, or comparing temperature variation among adjacent power conditioners.

19. The system of claim 15, wherein the at least one temperature reference is one or more of a temperature threshold, an expected temperature range, or an expected temperature curve.

20. The system of claim 15, wherein the at least one action comprises at least one of reporting the fire event or performing an action to mitigate the fire event.
